(19) United States
(12) Patent Application Publication
(10) Pub. No.: US 2013/0079931 A1
(43) Pub. Date: Mar. 28, 2013

(54) METHOD AND SYSTEM TO MONITOR AND CONTROL ENERGY

(71) Applicants: Mohan Wanchoo, Old Westbury, NY (US); Nirav . Shah, Huntington Station, NY (US); Gary Slattery, Nesconset, NY (US); David L. Leopold, Fort Lee, NJ (US); Nicholas Mervosh, Levittown, NY (US); Richard Strautman, Port Washington, NY (US)

(72) Inventors: Mohan Wanchoo, Old Westbury, NY (US); Nirav . Shah, Huntington Station, NY (US); Gary Slattery, Nesconset, NY (US); David L. Leopold, Fort Lee, NJ (US); Nicholas Mervosh, Levittown, NY (US); Richard Strautman, Port Washington, NY (US)

(21) Appl. No.: 13/245,236

(22) Filed: Sep. 26, 2011

(51) Int. Cl. G06F 1/32; G05D 23/19; G06F 1/28

(52) U.S. Cl. 700/278; 700/295; 700/296

(57) ABSTRACT

A system to monitor and control energy usage includes at least one consumer system and a control center that communicates with the at least one consumer system via the interne. Each consumer system includes a private network, at least one smart device that is configured to provide usage data across the private network, and a console. The console creates the private network, receives the usage data across the private network, sends the usage data across a communication channel, and enables a local user to control the at least one smart device and monitor energy usage of the at least one smart device. The control center is configured to receive the usage data across the communication channel from each console for storage thereon and enables a user remote to the consumer systems to control the smart devices and monitor energy usage of the smart devices.

### BACKGROUND

1. Technical Field

The present disclosure relates to a method and system to monitor and control energy usage.

2. Discussion of Related Art

Utilities throughout the United States and the world are confronting the challenge of managing their consumer's ever increasing demand for energy. Energy consumption has risen to alarming levels and has been the foremost concern of utilities and governments alike.

Residential, commercial and industrial establishments are typically provided with meters for measuring consumption of commodities, including electricity, gas and water, and other services, supplied to a building by utilities. For example, an electricity provider typically provides each consumer's premises with an electricity meter having a rotating disc and counter to measure and indicate cumulative usage in kilowatt hours (kWh), as a measure of usage or consumption of electrical energy for billing the consumer. Similar meters may be provided for gas, water or other services/supplies.

More recently, many utility companies have been installing “smart meters”, which can record cumulative or total energy usage and transmit the data to a central location, avoiding the need to employ a fleet of meter readers to take meter readings. Smart metering systems also facilitate data collection in terms of speed, accuracy and total cost of collection. Moreover, smart metering allows for more detailed monitoring of time of use, cost and other data. However, even with smart metering, the consumer may not receive information on consumption and cost from the utility provider until a bill is received.

Systems can be installed that allow an individual to turn/off their lights, appliances, television, sprinkler system, etc. by remote control or their personal computer. However, these systems do not incorporate the data received from the smart meters.

### BRIEF SUMMARY

According to an exemplary embodiment of the invention, a system to monitor and control energy usage is provided. The system includes at least one consumer system and a control center that communicates with the at least one consumer system via the internet. Each consumer system includes a private network, at least one smart device that is configured to provide usage data across the private network, and a console. The console creates the private network, receives the usage data across the private network, sends the usage data across the internet, and enables a local user to control the at least one smart device and monitor energy usage of the at least one smart device. The control center is configured to receive the usage data across the internet from each console for storage thereon and enables a user remote to the consumer systems to control the smart devices and monitor energy usage of the smart devices.

According to an exemplary embodiment of the invention, a system to monitor and control energy usage is provided. The system includes a plurality of smart devices, a private data network, a smart console that initiates the private network and controls access by the smart devices to the private network, and a control center. The smart devices provide usage data across the private network. The smart console sends the usage data received across the private network across a communication channel to the control center for storage thereon and enables a local user to control the smart devices and monitor their energy usage. The control center enables a user to remotely control the smart devices and monitor energy usage of the smart devices.

According to an exemplary embodiment of the invention, a method of controlling and managing energy usage is provided. The method includes creating, by a console of a consumer system, a private network to allow at least one smart device to connect to the private network, sending, by the console, usage data received from the private network across a communication channel to a control center, and controlling, by the control center, a corresponding one of the smart devices based on the received usage data. The controlling may include setting a corresponding one of the smart devices to a power-save mode if a current time is within a peak period and the usage data indicates that the smart device is non-essential.

### BRIEF DESCRIPTION OF THE SEVERAL VIEWS OF THE DRAWINGS

Exemplary embodiments of the invention can be understood in more detail from the following descriptions taken in conjunction with the accompanying drawings in which:

FIG. 1 depicts a system for monitoring and controlling energy usage according to an exemplary embodiment of the present invention.

FIG. 2 illustrates a method of managing smart devices according to an exemplary embodiment of the present invention.

FIG. 3 illustrates a method of controlling smart devices according to an exemplary embodiment of the present invention.

FIG. 4 illustrates a method of restoring a temperature when one of the smart devices is a cooling device according to an exemplary embodiment of the invention. FIG. 5 illustrates a method of restoring a temperature when one of the smart devices is a heating device according to an exemplary embodiment of the invention.

FIG. 6 illustrates an example of screen of a smart console of the system.

FIG. 7 illustrates an example of another screen of the smart console of the system.

FIG. 8 illustrates an example of a computer system, which may be used to implement the system, or portions thereof, according to an exemplary embodiment of the present invention.

### DETAILED DESCRIPTION

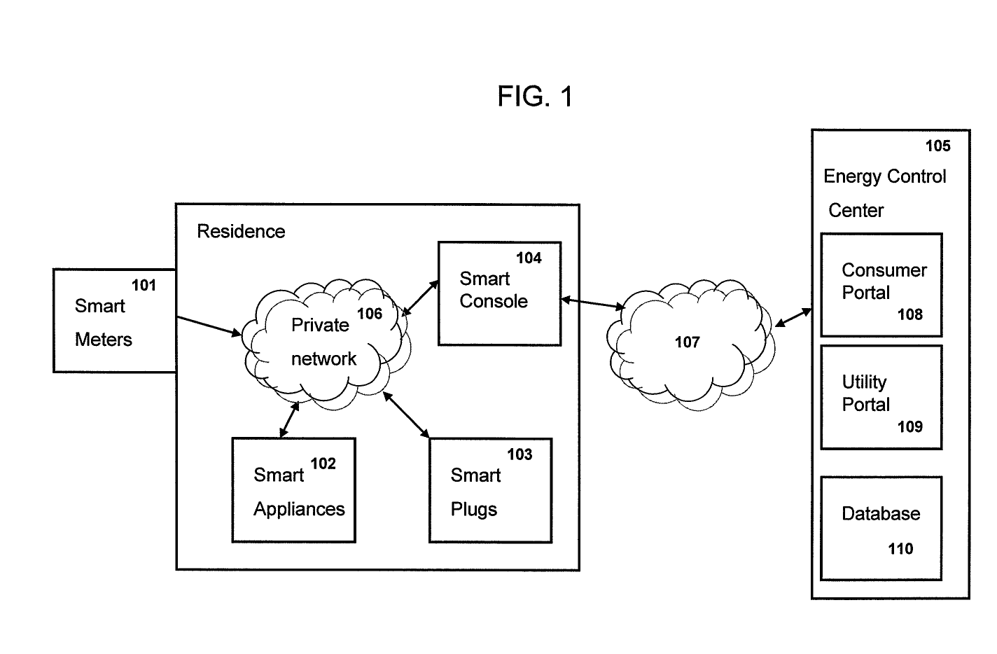

FIG. 1 depicts a system for monitoring and controlling energy usage according to an exemplary embodiment of the invention. Referring to FIG. 1, the system includes a smart console 104 and an energy control center (ECC) 105. The smart console 104 may be referred to as the Home Area Network (HAN) console, which acts as the on-premises hub and controller for all the smart devices connected to the network 106 in the consumer's home. The smart console 104 may be mounted to a wall of the residence. The smart console 104 captures usage data from whatever smart devices are available within the residence, e.g., smart meter(s) 101, smart appliance(s) 102, smart plugs 103, etc. The Smart Console 104 can read usage data from the smart devices on a one-to-many basis. For example, several of the smart devices can be read together at one time by the Smart Console 104.

The consumer can monitor and control the system from the smart console 104. The smart console 104 allows the consumer to monitor, schedule, and conserve their energy usage. For example, the smart console 104 includes a display for displaying information. The display may be a touch-screen that allows entry of commands or the smart console 104 may include physical buttons for entry of commands. The smart console 104 also responds to commands from the ECC 105.

The smart meter(s) 101 may include at least one of automatic meter reading (AMR) meters and advanced metering infrastructure (AMI) meters. AMR may include meters where aggregated kWh usage, and in some cases demand, can be retrieved via an automatic means such as a drive-by vehicle, a walk-by handheld system, or by the smart console 104. AMR systems can typically provide the kWh reading and possibly peak kW demand for the month. AMI may include meters that record customer consumption hourly (or more frequently) and that provide for daily (or more frequent) transmittal of measurements over a communication network to the Smart Console 104. AMI typically provides a substantial payload of information, such as cumulative kWh usage, daily kWh usage, peak kW demand, last interval demand, load profile, voltage, voltage profile, logs of voltage sag and swell events, voltage event flags, phase information, outage counts, outage logs, tamper notification, power factor, and time-of-use kWh and peak kW readings.

The smart appliances 102 may include appliances that have embedded smart meters to log and report their consumption of electricity to the Smart Console 104. The smart appliances 102 may include a control mechanism that allows them to receive and operate on commands from the Smart Console 104, a remote control, a personal computer, mobile device, etc. For example, the commands may be for scheduling the appliance to be turned on/off during particular periods, setting the appliance to particular modes of operation (e.g., a power-save mode), etc. The smart appliances 102 may be various electronic devices such as a dishwasher, clothes washer, clothes dryer, refrigerator, lamp, television, digital video recorder, oven, stereo, air conditioner, water heater, etc. Along with consumption information, the smart appliances 102 can provide identify information to the central location. For example, the identity information can indicate the type of the appliance (e.g., lamp, refrigerator), a model number, etc.).

A Smart Plug 103 plugs into a wall socket and a non-smart appliance is then plugged into the smart plug. The smart plug 103 captures consumption data of the non-smart appliance and transmits that data back to the Smart Console 104. A Smart Plug 103 may include a control mechanism that allows it to receive and operate on commands from the Smart console 104, a remote control, a personal computer, mobile device, etc. For example, the commands can be used to schedule the connection/disconnection of power delivered by the corresponding outlet to the non-smart appliance.

The smart devices may communicate wirelessly. When turned on, the Smart Console 104 can setup its own private network 106 and grant the smart devices access to the private network. Thus, the system is not dependent on the network formed by AMI or AMR meters. For example, the system is not dependent on the communication protocol of the meters. The Smart Console 104 accepts both Home Automation HA and Smart Energy SE devices.

The private network 104 may be a wireless network, such as ZigBee. ZigBee is a specification for a suite of high level communication protocols using small, low-power digital radios based on the IEEE 802.15.4-2003 standard for Low-Rate Wireless Personal Area Networks (LR-WPANs).

The Smart Console 104 can capture usage data from the Smart Meters 101 in a “read-only” fashion. The Smart Console 104 can communicate bi-directionally with the Smart appliance(s) 102 and the Smart plug(s) 103. For example, the Smart Console 104 can receive consumption data from and send control commands to the Smart Appliance(s) 102 and the Smart Plug(s) 103. The Smart Console 104 may include a database to store the data. For example, the Smart Console 104 may include a relational database server such as Microsoft SQL compact edition™. However, the present invention is not limited to any particular type of database, as the data could be stored as flat files or in various other relational databases.

While the smart devices and the Smart Console 104 are described as being located within a residence, the present invention is not limited thereto. For example, the smart devices and the Smart Console 104 may be located with a commercial or government environment (e.g., a restaurant, an office building, a post office, etc.).

The data and actions of the Smart Console 104 may be communicated via a communication channel 107 to the ECC 105, which acts as a data repository and enables various applications. Examples of the communication channel 107 include the internet, wireless networks, power line communications, cell phone networks, and various other wired networks. The ECC 105 includes several sub-systems and provides services for data collection, data storage, communications, event processing, and other core services. For example, the ECC 105 may include a database 110 to store the data, which may be a relational database.

The ECC 105 provides at least one web portal, such as a Consumer Portal 108 and a Utility Portal 109. The Consumer Portal may also be referred to as the Customer Portal. Consumers have access to the Consumer Portal 108 through the communication channel 107 via a computer, mobile device, etc., which allows them to view their consumption data and control (e.g., power on/off, set to different operation modes, etc.) their smart devices using commands. The display of the Smart Console 104 or a graphical user interface (GUI) of the Consumer Portal 108 may be used to display the consumption data and controls for managing their consumption (e.g., controls to turn on/off, schedule the on/off of an appliance).

Using the Smart Console 104 or the Consumer Portal 108, a consumer can view energy usage in real-time by appliance. The usage of each appliance can be aggregated to show a consumer their total energy usage or the total energy usage for an appliance type (e.g., only the lights, only the televisions, etc.). Further, since the ECC 105 has the data of other consumers, it can provide information on how usage of one consumer compares to the average consumer (e.g., 10% less than average consumer, 40% more than the average user, etc.). Further, the ECC 105 can analyze the consumption data to determine the ratio of energy usage of a single appliance as compared to the total energy usage of the consumer.

A utility is provided access to the ECC 105 through the Utility Portal 109, which accesses data from the ECC 105 to enable the utility to analyze the consumption data and run reports. The Utility Portal 109 allows a utility to generate detailed analytical reports. For example, the utility can request a list of the consumers that are regularly using more than a certain amount of power and use this information to determine consumers who should be sent incentives to conserve on their power usage or advice on how they can conserver power usage.

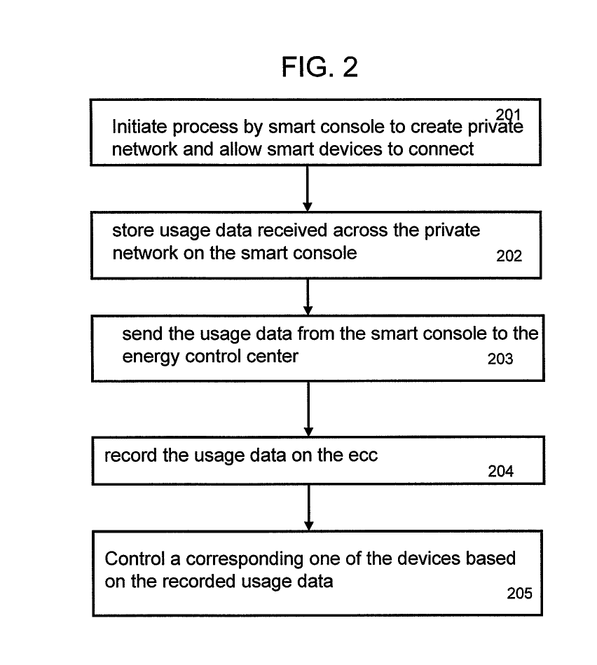

FIG. 2 illustrates a method of managing smart devices according to an exemplary embodiment of the present invention. Referring to FIG. 2, the method includes the Smart Console 104 initiating a process to create a private network (e.g., using Zigbee) and allow smart devices to connect (S201), the Smart Console 104 storing usage data received across the private network (S202), the Smart Console 104 sending the usage data to the ECC 105 (S203), the ECC 105 storing the usage data (S204), and the ECC 105 controlling a corresponding one of the devices based on the recorded data (S205). The Smart Console 104 may send its own unique identifier along with its usage data. For example, the ECC 105 may store the usage data of each Smart Console 104 and its corresponding identifier as entries in a table of the database 110.

The ECC 105 may control the corresponding device by issuing Demand Response or Load Shedding commands. For example, the ECC 105 may be configured to send curtailment and/or load control signals to the Smart Console 104. For example, the Demand Response or Load Shedding commands/signals may be used to raise/lower the temperature of the residence or cycle appliances on/off.

The Smart Console 104 or a user interface of the Consumer Portal 108 may provide an opt-in option that allows a consumer to opt-in to the Demand Response features. The Demand Response features may include automated Demand Response events such as Day Ahead Demand Response Programs (DADRP) or Emergency Demand Response Programs (EDRP).

The ECC 105 can monitor and record data of the Smart Console 104 that have participated in a Utility's Demand Response Event. For example, the ECC 105 can analyze the amount of electric load that was shed during the event against the projected load for that event. Forecasts can then be created to give the utility a bench mark on how much load would need to be shed in a future Demand Response event. The utility can then take proactive steps to gain additional participation to meet or exceed the load shed goal if there is a deficit.

The system may allow a user to cycle back usage of non-essential appliances during peak time periods. For example, the system may allow the consumer or the utility to designate that some of the appliances being monitored are non-essential or non-essential only during certain periods, and the time periods that are considered the peak time periods. For example, the utility could designate 7 am-9 am as the peak period, while the consumer could designate some of their lights as being non-essential, and thus the ECC 105 could automatically cycle off the corresponding lights when the current time is within the peak time periods.

The peak periods may be calculated automatically by the ECC 105 or the Smart Console 104 based on past energy usage of the residence. For example, the ECC 105 or the Smart Console 104 may log periods of energy usage and set the peak period to the logged period with the highest energy usage. Further, since the ECC 105 has access to the data of other residences and businesses, the ECC 105 may calculate an overall peak period for use to cycle off the non-essential appliances designated by all the residences and businesses.

Consumers can permit utilities to remotely control their appliances and devices based on a combination of environmental and consumer needs such as time of using pricing and supply conditions. For example, the utility may designate that certain periods of power usage have a having higher cost and the consumer could designate that certain appliances be controlled by the utility company to minimize their usage during these high cost periods.

During a curtailment event, the Smart console 104 may send a wireless signal to a Smart Appliance 102 or a Smart plug 103, curtailing its usage based on a predetermined cycling strategy (e.g., cycle off the designated non-essential appliances during the established peak time periods) or by direct consumer control.

However, if a cooling/heating device marked as a non-essential device is turned off during a curtailment event, it make take a considerable amount of time before the temperature of the room has been restored to its previous level after the device has been turned on. The system (e.g., the Smart Console 104 or the ECC 105) can control the cooling/heating appliance to work “overtime” during a “payback period” after the curtailment event to return the temperature of the room more quickly to its original value. The system can do this based on a feedback of the current temperature received from a temperature sensor, which may be located within the Smart Console 104, may be one of the smart meters 101, or part of a smart thermostat.

As an example, the consumer may designate an air-conditioner as non-essential and supply a desired room temperature or range to the Smart Console 104. After a curtailment event has ended and the air-conditioner had been cycled off during the curtailment event, if the sensed temperature is above the desired temperature range, the thermostat setting can be adjusted to a setting that is lower than its original setting. The temperature can then be periodically monitored until it reaches the desired range, and then the thermostat setting can be restored its original setting.

The ECC 105 can control the thermostat based on temperature data and consumption data sent by the Smart Console 104. Alternately, the Smart Console 104 can control the thermostat independent of the ECC 105.

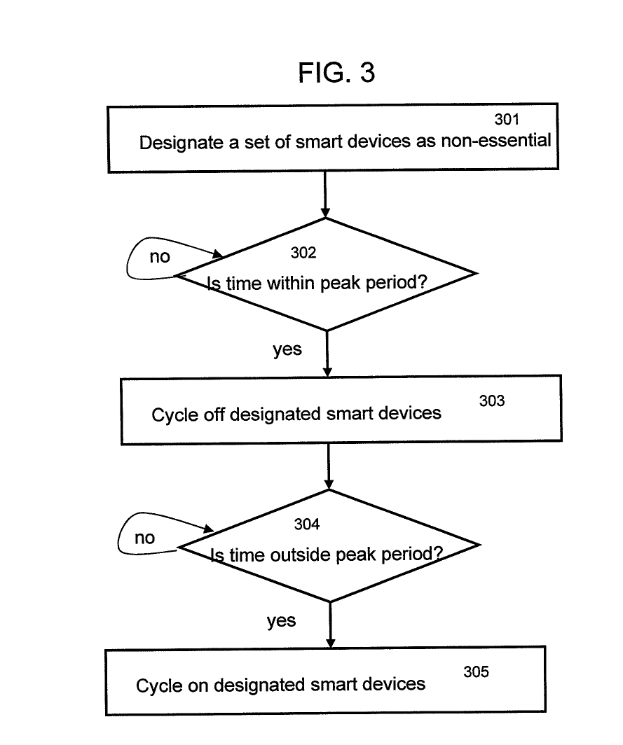

FIG. 3 illustrates a method of controlling smart devices according to an exemplary embodiment of the present invention. Referring to FIG. 3, the method includes designating a set of smart devices as non-essential (S301), determining whether the current time is within a peak time period (S302), cycling off the designated devices when the current time is within the peak time period (S303), determining whether the current time is outside the peak time period (S304), and cycling on the designated devices when the current time is outside the peak time period (S305). The designating of the non-essential devices may be done by the consumer or the utility. For example, when this designation is performed by the utility, the method may be modified such that the later steps are only performed if the consumer has opted-in for Demand Response. The ECC 105 may determine whether the current time is within the peak time period. The peak time period may have been set previously by the utility, or the method may be modified to include a step of designating the peak time period. In an alternate embodiment, a device may be set to a power-save mode instead of cycling it off, and then set to a normal power mode instead of cycling it on. The power-save mode may be a lower setting of operation (e.g., low cool, a thermostat setting of 66 degrees Fahrenheit, etc.).

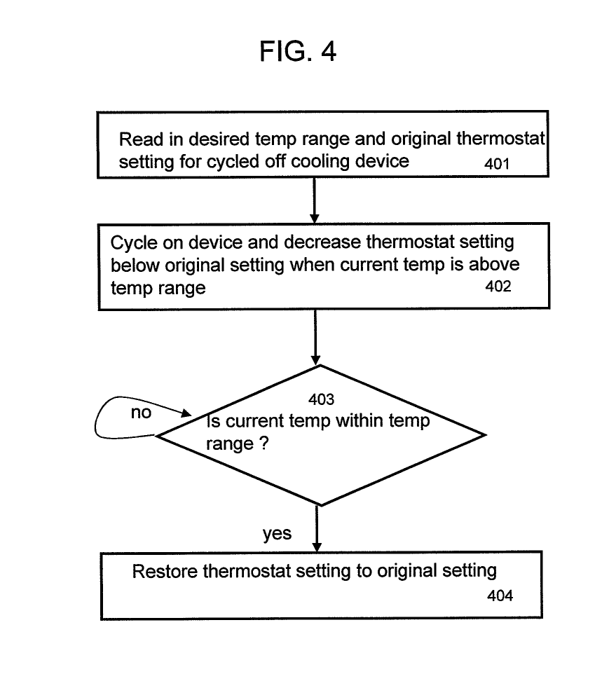

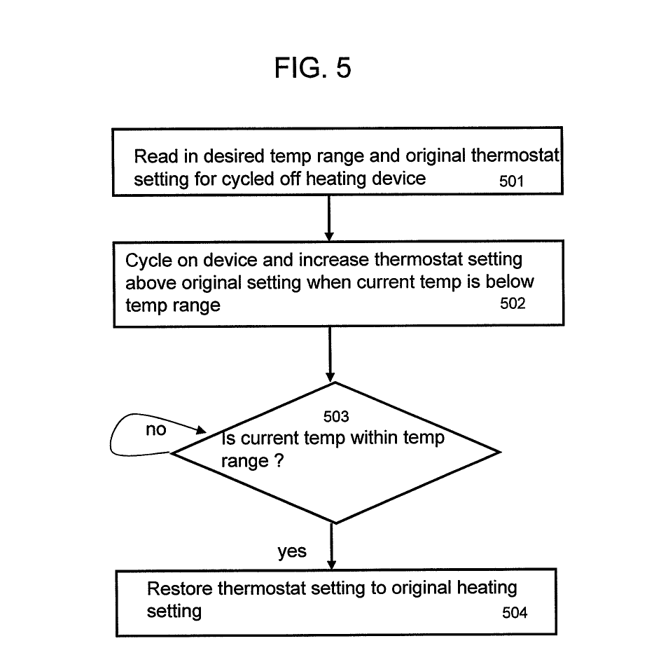

FIG. 4 illustrates a method of restoring a temperature when one of the designated devices is a cooling device according to an exemplary embodiment of the invention. Referring to FIG. 4, the method includes reading in a desired temperature range and an original thermostat setting for the cycled ‘off’ cooling device (S401), cycling ‘on’ the device and decreasing the thermostat setting below the original thermostat setting when the current temperature is above the desired temperature range (S402), determining whether the current temperature is within the desired temperature range (S403), and setting the thermostat setting to the original thermostat setting when the current temperature is determined to be within the range (S404).

FIG. 5 illustrates a method of restoring a temperature when one of the designated devices is a heating device according to an exemplary embodiment of the invention. Referring to FIG. 5, the method includes reading in a desired temperature range and original thermostat setting for the cycled ‘off’ heating device (S501), cycling ‘on’ the heating device and increasing the thermostat setting above the original thermostat setting when the current temperature is below the desired temperature range (S502), determining whether the current temperature is within the desired temperature range (S503), and setting the thermostat setting of the device to the original thermostat setting when the current temperature is determined to be within the range (S504).

When the cooling/heating device is originally designated a non-essential device in the method of FIG. 3, the user may have been prompted to identify the device as a cooling or a heating device and/or whether they want a payback period to be applied to the device. If the user desires a payback period, then the user can be prompted for the desired temperature range and the original thermostat setting. Alternately, the original thermostat setting may be received from one of the smart devices (e.g., a central air conditioning smart device, smart thermostat, etc.). Further, the desired temperature range may be determined automatically based on a current temperature output by one of the smart devices prior to the device being cycled off. When the device is set to the power-save mode or lower setting of operation, the cycling on/off in the methods of FIG. 4 and FIG. 5 may be omitted.

The system can work in parallel with a utility's current curtailment and communications process. In this way, the ECC 105 can provide built in redundancy and flexibility. In at least one embodiment of the invention, via the ECC 105, the utility has sole discretion as to whether to send curtailment signals through their own meters, or by using the ECC 105 in parallel to send curtailment data, load control data, and messages.

Control of temperature may be provided by the system independent of the Demand Response features. For example, the Smart Console 104 can replace the existing thermostat or be interfaced with the existing thermostat to allow a user to remotely set, control, and schedule the temperature of their residence or business.

The system may also be configured to provide alerts to the consumer or the utility, by sending text messages, emails, instant messages, etc. For example, the consumer could designate that a warning be sent in a text message to a particular phone number if certain appliances have been in use for more than certain periods of time (e.g., “send alert to 555-1234 if iron on more than 30 minutes”. For example, the consumer may setup these warning through the Smart console 104 or the Consumer portal 108. If the warning is sent in a text message, the user may reply to the text message with a special command (e.g., “off”) to remotely turn off the appliance. The Smart Console 104 or the ECC 105 can monitor whether warnings need to be sent based the designated warning criteria and the consumption data, and report accordingly.

The ECC 105 can calculate potential savings of a consumer based on recent usage of resources captured by the Smart console 104 and recent pricing information. As an example, the ECC 105 may receive the pricing information from a utility via the Utility Portal 109. The ECC 105 can generate recommendations on how to achieve a targeted reduction in energy usage based on usage and pricing data collected. For example, the ECC 105 could recommend using a particular smart appliance (e.g., clothing dryer) during a time period in which electricity rates are lower. A user can view these recommendations on the Smart console 104 or via the Consumer Portal 108.

When the ECC 105 receives usage data from multiple smart consoles, the ECC 105 can compare the usage of each consumer to generate statistics. The statistics could indicate how usage of a consumer compares to other consumers (e.g., “using more energy than 90% of consumers”) or indicate the average usage of a particular region (e.g., per block, city, state, etc.). The ECC 105 can provide these statistics to the consumers, utilities, or others. For example, the ECC 105 can provide the average usage rates for the state in which a consumer lives; provide published national averages, etc. A consumer can view these statistics to the Smart console 104 or via the Consumer Portal 108. A utility can view these statistics via the Utility Portal 109.

The ECC 105 can also allow a consumer to create a savings goal (e.g., reduce energy usage by 10%) using the Smart Console 104 or the Consumer Portal 108. The ECC 105 can record the savings goal of each consumer and calculate their progress based on collected usage data. The consumer can view their savings goal and progress on the Smart Console 104 or via the Consumer Portal 108.

The system may be configured to generate a response to a utility requesting additional information, which can be used to trigger an automated response back from the utility such as an email or text to the consumer's contact address.

The Smart Console 104 may be configured to execute a diagnostic test on the private network 106 and/or a smart device to indicate the health of the network and/or the smart device, and report the results on its display or to the ECC 105. A user may initiate these tests from the Smart Console 104, the Consumer Portal 108, or the Utility Portal 109.

The ECC 105 may also allow for “plug-ins” from third party applications.

The system can work as a backup to the AMI structure, or can be used to send and receive utility signals when a utility AMI structure is not in place.

The display of the Smart Console 104 or the GUI of the Consumer Portal 108 can be used to display advertisements to the consumer. The advertisements can be text, images or both. The system can provide an opt-in choice via its bi-directional message capability to receive additional information on the product or service. Such opt-ins can include a request for an email or text message to be sent to the address or phone number of choice.

Further, the system can be used to verify renewable energy production. For example, smart meters reporting on the renewable energy production (e.g., solar energy from a solar panel, wind energy from a wind turbine, etc.) can be interfaced with the Smart Console 104. These smart meters can then report on the amounts of energy being produced to verify whether the consumer is entitled to a discount for using renewable energy. Further, when at least a portion of the renewable energy is sent to the shared power grid, a meter monitoring such can send a measure of the energy produced to the Smart Console 104, and then forward it to the ECC 105 for verification by one or more remote users.

Embodiments of the system may incorporate both the Smart Energy SE Profile and Home Automation HA network functionality into a single platform. For example, SE and HA functionality do not need to be programmed separately for their specific functions.

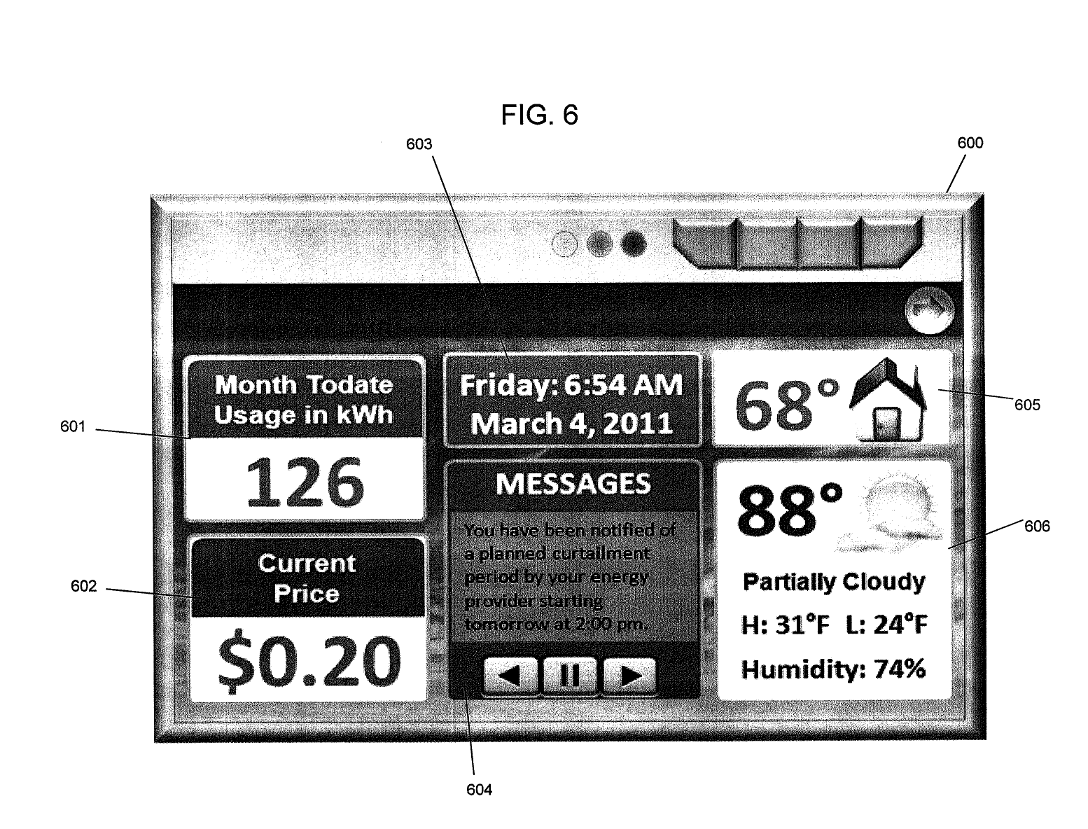

FIG. 6 illustrates an example of a screen 600 of the Smart Console 104. Referring to FIG. 6, the screen 600 includes a usage field 601, a price field 602, a date field 603, a message field 604, a temperature field 605, and a weather field 606. One or more of the fields of the screen 600 may be hidden or omitted in alternate embodiments. Further, in alternate embodiments, the screen 600 may include additional data fields or options.

The usage field 601 indicates the amount of energy used by the consumer during a given period (e.g., a number of kilowatt hours kWh used during the month). The price field 602 indicates the current price for a given unit of energy (e.g., 20 cents a kWh). The date field 603 indicates the current time and date. The message field 604 can be used to provide information to the consumer, such as the recommendations, a schedule of curtailment events, power-reducing incentives, statistics, etc. The temperature field 605 indicates the current temperature sensed by the Smart Console 104.

The weather field 606 indicates the current weather for an area near the Smart Console 104. The weather data may be provided by the ECC 105. The ECC 105 can download weather data from the communication channel 107 that is appropriate for the geographic location of each attached Smart Console 104. The ECC 105 can periodically upload the appropriate weather data to each Smart Console 104. In an alternate embodiment, the Smart Console 104 can periodically request this weather data from the ECC 105 or download this information from the communication channel 107 from another source.

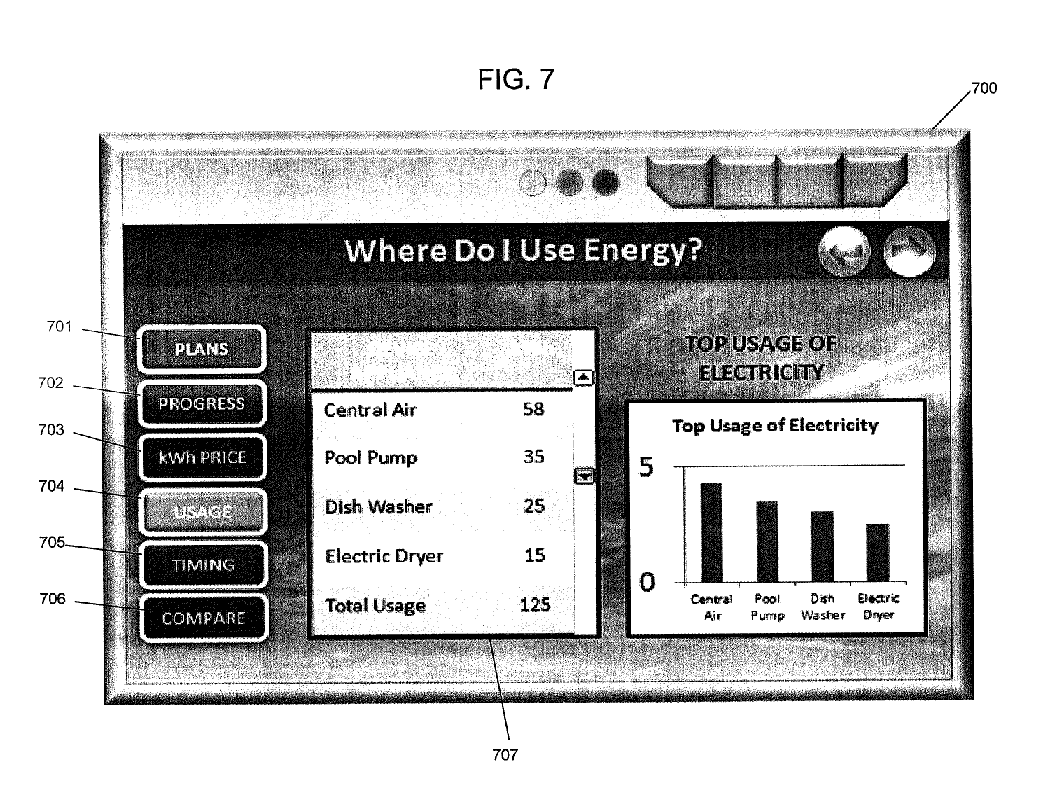

FIG. 7 illustrates an example of another screen 700 of the Smart Console 104. Referring to FIG. 7, the screen 700 includes various controls, such as a plans control 701, a progress control 702, a price control 703, a usage control 704, a timing control 705, and a compare control 706. Some of the controls may be hidden or omitted in alternate embodiments. Further, the screen 700 may include additional controls, features, or options in alternate embodiments. The plans control 701 allows a consumer to display planned events. Selection of the plans control 701 brings up a screen that enables the user to create a savings plan with a savings goal or target. Selection of the progress control 702 allows the user to measure their progress against their goal/savings plan. The price control 703 allows the consumer to display the current cost of using a given amount of energy. The usage control 704 allows a consumer to display the amount of energy used, which may be broken down per smart device. Selection of the timing control 705 brings up a screen that allows the user to view how much energy they use and during what times or time periods they use this energy. For example, the screen could indicate that a consumer uses an average of a certain number of KWH each morning. The compare control 706 can be used to display how the usage of the consumer compares to other consumers in the same area, or a different area, such as a different city, state, etc. Further, the screen 700 includes a device field 707, which lists each smart device that is being monitored by the system. The device field 707 may also be used to name a particular smart device. For example, if a non-smart device (e.g., a simple lamp) is connected to a Smart Plug 103 attached to the Smart Console 104, the entry for the Smart Plug 103 in the device field 707 may need to be manually set by the consumer. The device field 707 may also list the amount of energy that each smart device uses.

While the invention has been described above with respect to consumption of energy by devices that use electricity, the present invention is not limited to thereto. For example, the smart meters 101 may report on the consumption of various resources such as oil, gas, water, traffic counts, and surveillance data.

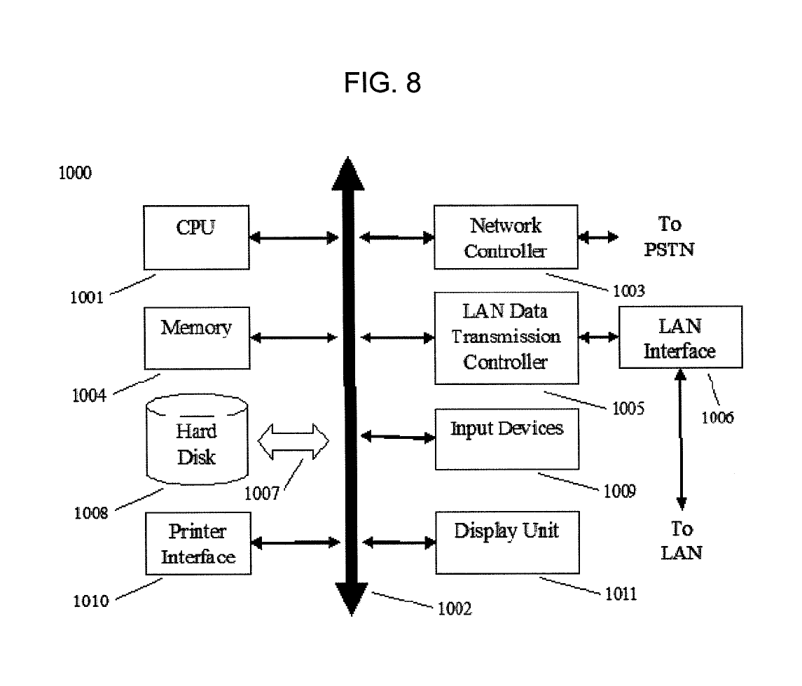

FIG. 8 illustrates an example of a computer system, which may be used to implement the Smart Console 104, the ECC 105, used to launch the Consumer Portal 108, the Utility Portal 109, or used to execute the above described methods, according to exemplary embodiments of the invention. The methods of FIGS. 2-5 may be implemented in the form of a software application running on the computer system. Examples of the computer system include an embedded system, a personal computer (PC), handheld computer, a server, etc. The software application may be stored on a computer readable media (such as hard disk drive memory 1008) locally accessible by the computer system and accessible via a hard wired or wireless connection to a network, for example, a local area network, or the Internet.

The computer system referred to generally as system 1000 may include, for example, a central processing unit (CPU) 1001, random access memory (RAM) 1004, a printer interface 1010, a display unit 1011, a local area network (LAN) data transmission controller 1005, a LAN interface 1006, a network controller 1003, an internal bus 1002, and one or more input devices 1009, for example, a keyboard, mouse etc. For example, the display unit 1011 may display the consumption data on the Smart Console 104, display the GUI of the Consumer Portal 108, etc. As shown, the system 1000 may be connected to a data storage device, for example, a hard disk 1008, via a link 1007. CPU 1001 may be the computer processor that performs the above described methods.

It is to be understood that the systems and methods described above may be implemented in various forms of hardware, software, firmware, special purpose processors, or a combination thereof. In particular, at least a portion of the present invention may be implemented as an application comprising program instructions that are tangibly embodied on one or more computer readable medium(s) (i.e., program storage devices such as a hard disk, magnetic floppy disk, RAM, ROM, CD ROM, etc., and executable by any device or machine comprising suitable architecture, such as a general purpose digital computer having a processor, memory, and input/output interfaces). It is to be further understood that, because some of the constituent system components and process steps depicted in the accompanying figures may be implemented in software, the connections between system modules (or the logic flow of method steps) may differ depending upon the manner in which the present invention is programmed. Given the teachings herein, one of ordinary skill in the related art will be able to contemplate these and similar implementations of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

It is to be understood that exemplary embodiments disclosed above are illustrative only, as the invention may be modified and practiced in different but equivalent manners apparent to those skilled in the art having the benefit of the teachings herein. It is therefore evident that exemplary embodiments disclosed herein may be altered or modified and all such variations are considered within the scope and spirit of the invention.

What is claimed is:

1. A system to monitor and control energy usage, the system comprising:
at least one consumer system; and
a control center that communicates with the at least one consumer system via a communication channel,
wherein each consumer system comprises:
a private network;
at least one smart device that is configured to provide usage data across the private network;
a console configured to create the private network, receive the usage data across the private network, send the usage data across the communication channel, and enable a local user to control the at least one smart device and monitor energy usage of the at least one smart device,
wherein the control center is configured to receive the usage data across the communication channel from each console for storage thereon and enables a user remote from the consumer systems to control the smart devices and monitor energy usage of the smart devices.

2. The system of claim 1, wherein the usage data is sent over the private network using a Zigbee communications protocol.

3. The system of claim 1, wherein the smart devices include at least one of a smart meter, a smart appliance, and a smart plug.

4. The system of claim 1, wherein the control center includes an application that provides a web portal through which messages are transmitted by the remote user to control the smart devices and monitor the energy usage of the smart devices.

5. The system of claim 4, wherein the control center is configured to send commands through the web portal to a corresponding one of the consoles for operation thereon.

6. The system of claim 1, wherein the console is configured to read usage data from at least two of the corresponding smart devices at the same time.

7. The system of claim 1, wherein the console is configured read usage data having an automatic meter reading (AMR) data format and usage data having an advanced metering infrastructure (AMI) data format.

8. The system of claim 1, wherein each console provides its own unique identifier along with its usage data to the control center and a database of the control center stores a plurality of entries, where each entry includes the usage data and a corresponding one of the unique identifiers.

9. The system of claim 1, wherein the console is configured to provide a ratio of the energy usage of one of the smart devices as compared to the total energy usage of all the smart devices of the console.

10. The system of claim 1, wherein at least one of the smart devices provides usage data on a source of renewable energy to the control center.

11. The system of claim 1, wherein the console includes an opt-in function that allows the local user to opt-in to a demand response event and the control center records the consoles that are participating in the demand response event.

12. The system of claim 11, wherein the control center is configured to provide an analysis on the usage data of those that participated in the event against a projected load shedding amount to predict how much load will be shed in a future such event.

13. The system of claim 1, wherein the console includes a thermostat interfaced with a heating system or a cooling system and settings of the thermostat can be adjusted using the console and the control center.

14. A method of controlling and managing energy usage, the method comprising:
establishing, by a console of a consumer system, a private network to allow at least one smart device to connect to the private network;
sending, by the console, a first message including usage data received from the private network from the smart devices across a communication channel to an external control center;
determining, by the control center, a schedule for the smart devices based on the usage data received in the message;
sending, by the control center, a second message including commands based on the schedule across the communication channel to the console; and
executing, by the console, the commands in the second message to control the smart devices.

15. The method of claim 14, wherein the usage data is sent over the private network using a Zigbee communications protocol.

16. The method of claim 14, wherein the smart devices include at least one of a smart meter, a smart appliance, and a smart plug.

17. The method of claim 14, wherein when the control center determines that a current time is within a peak period and the usage data indicates that one of the smart devices is non-essential, execution of one the commands sets the corresponding smart device to a power-save mode.

18. The method of claim 14, wherein the first message includes a device identifier of the console, the method further comprising storing, by the control center, a data record including the device identifier and the usage data

19. A method of controlling and managing energy usage, the method comprising:
establishing, by a console of a consumer system, a private network to allow at least one smart device to connect to the private network;
sending a first message from an external control center to the console across a communications channel, the first message indicating a time period of a curtailment event;
displaying, by the console, the time period of the curtailment event and an option that when selected indicates opting into the curtailment event;
sending a second message from the console across the communications channel to the control center to indicate opting into the curtailment event when the option is selected; and
sending a third message from the control center across the communication channel to the console including a command to control one of the smart devices during the time period to reduce its power consumption in response to the second message.

20. The method of claim 19, wherein the command is sent to the corresponding smart device across the private network using a Zigbee communications protocol.
